(19) United States
(12) Patent Application Publication
(10) Pub. No.: US 2007/0092419 A1
(43) Pub. Date: Apr. 26, 2007

(54) METHOD FOR REMOVAL OF MERCURY IN GAS STREAMS

(75) Inventors: MAOHONG FAN, Ames, IA (US); GLENN A. NORTON, Ames, IA (US); ROBERT C. BROWN, Ames, IA (US)

Correspondence Address: MCKEE, VOORHEES & SEASE, P.L.C., 801 GRAND AVENUE, SUITE 3200, DES MOINES, IA, 50309-2721, US

(73) Assignee: IOWA STATE UNIVERSITY RESEARCH FOUNDATION, INC., Ames, IA (US)

(21) Appl. No.: 11/553,317

(22) Filed: Oct. 26, 2006

Related U.S. Application Data
(60) Provisional application No. 60/730,515, filed on Oct. 26, 2005.

(51) Int. Cl. B01D 53/64

(52) U.S. Cl. 423/210

(57) ABSTRACT

The present invention relates to an improved means of removing mercury from industrial gas streams. The method involves contacting the mercury-containing gas stream with an iron-containing sorbent at a first temperature ranging between 100-350° C. The iron sorbent appears also to be regenerable by heating the sorbent to a second temperature ranging from about 350-500° C.

### CROSS-REFERENCE TO RELATED APPLICATIONS

This application claims priority under 35 U.S.C. § 119 of a provisional application Ser. No. 60/730,515 filed Oct. 26, 2005, which application is hereby incorporated by reference in its entirety.

### BACKGROUND OF THE INVENTION

Mercury, a natural metal that does not break down, is a recognized hazardous pollutant that is extremely persistent in our environment. Upon being released to the atmosphere, mercury settles into water bodies, where it is transformed by bacteria into methylmercury. In this form, it becomes more concentrated at higher levels of the food chain. Consequently, the highest levels are found in large, predatory fish and in fresh water fish that are closer to sources of mercury pollution.

People are often exposed to mercury by eating contaminated fish. A mere gram of mercury emitted into a 20-acre lake can cause fish to become unsafe for human consumption. Exposure to very low doses of mercury during vulnerable periods of brain development may result in impaired attention, memory, verbal learning, vocabulary, and neuromotor function. According to the National Academy of Sciences (NAS), more than 60,000 U.S. children are born each year at risk for adverse neurodevelopmental effects, including poorer school performance, due to in utero exposure to mercury.

Mercury (Hg) is listed as a hazardous air pollutant (HAP) in the 1990 Amendments to the Clean Air Act. Coal-fired power generation emits on the order of 50 tons of Hg annually and accounts for about a third of the total annual anthropogenic Hg emissions in the U.S. In view of concerns over health and environmental impacts related to Hg, the U.S. Environmental Protection Agency has decided to regulate Hg emissions from coal-fired power plants.

Flue gas from coal combustion contains both elemental and oxidized Hg. The relative concentrations of elemental and oxidized Hg varies widely from plant to plant, depending on a variety of fuel, plant design, and plant operating variables. The relative concentrations of different Hg species are a major factor affecting Hg removal efficiencies by Hg abatement technologies. However, because the chemistry affecting the Hg speciation in coal combustion flue gas is poorly understood, it is difficult to predict Hg removal efficiencies for any given Hg abatement technology.

In view of the pending need for mercury control technologies at coal-fired power plants, a great deal of effort has been expended at facilities to study post-combustion mercury removal options. Options that have been tested include injection of sulfide-containing liquors, oxidation of elemental mercury for enhanced mercury removal by wet scrubbers, the use of solid sorbents, and the use of substrates coated with noble metals. The oxidative methods include the use of solid catalysts, liquid oxidants, photochemical oxidation, and corona discharge plasmas.

The vast majority of work performed on mercury abatement has involved sorbent injection. Although numerous sorbent materials have been studied, activated carbons have appeared to be the most promising, and have by far received the greatest attention. Despite the popularity of activated carbons, problems have been noted with respect to rapid breakthrough of mercury (from fixed beds) in the presence of various flue gas constituents, mass transfer limitations, large negative impacts of SO₂ and HCl on equilibrium adsorption capacity for some activated carbons, and decreased reactivity and sorption capacity at typical duct injection temperatures. In addition to these technical difficulties, post-combustion control of mercury through sorbent injection can prove to be prohibitively costly. In this respect, when using sorbent injection in conjunction with other mercury control strategies, removing 90% of the mercury from coal-derived flue gas is expected to cost billions of dollars annually.

Rather than injected activated carbon in flue gas exiting their boilers for post-combustion control, there has been increased interest in removing mercury from the coal before it is burned, i.e. precombustion control. In this approach, the coal is heated to 300° C. in an inert carrier, which drives out most of the mercury as elemental vapor. The concentration of mercury in the carrier gas is greater than in flue gas, thus facilitating mercury recovery compared to post-combustion clean up. Ideally, the carrier gas is not cooled to recover the mercury, but instead stripped of mercury at 300° C. and recycled to the coal pretreatment system.

In spite of the on-going developmental efforts, current methods of removing mercury pollutants from industrial processes are deficient for various reasons.

It is therefore a primary objective of the present invention to provide a physico-chemical method for removing mercury using a sorbent material.

It is a further objective of the present invention to provide a method of removing mercury from gas streams using an iron-containing sorbent.

It is still a further objective of the present invention to provide a method of removing mercury from gas streams using iron-containing particles.

It is yet a further objective of the present invention to provide a method of removing mercury from gas streams.

The method and means of accomplishing each of the above objectives as well as others will become apparent from the detailed description of the invention which follows hereafter.

### SUMMARY OF THE INVENTION

Described herein is a method of precombustion removal of mercury from an industrial gas waste stream. The method involves heating a mercury material to generate a gas stream, then contacting the gas stream with an iron-containing sorbent. The sorbent preferably consists of iron particles of a size of 100 mesh or less. The gas stream is heated to a temperature sufficient to chemisorb the mercury onto the sorbent, which generally ranges between about 100-350° C. Once chemisorbtion is complete, the sorbent is heated to a second temperature that is sufficient to regenerate the sorbent, which generally ranges between about 350-500° C.

The method of the invention provides nearly 100% chemisorption of mercury onto the iron sorbent at a temperature approximating that necessary for thermal evolution of mercury from coal prior to combustion. In addition, the iron sorbent is regenerable following further heating at a second higher temperature range in a substantially inert environment.

### DETAILED DESCRIPTION OF THE DRAWINGS

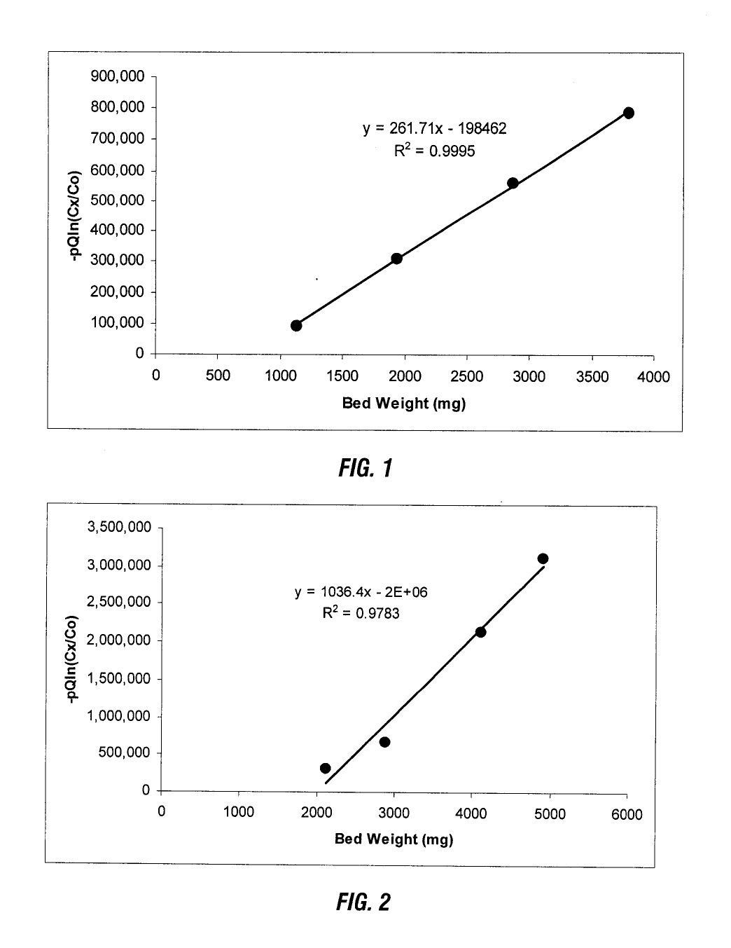

FIG. 1 illustrates the results obtained from the Wheeler equation for tests performed with a flow rate of 100 mL/min and a furnace temperature of 275° C., as set forth in Example 1.

FIG. 2 illustrates the results obtained from the Wheeler equation for tests performed with a flow rate of 300 mL/min and a furnace temperature of 275° C., as set forth in Example 1.

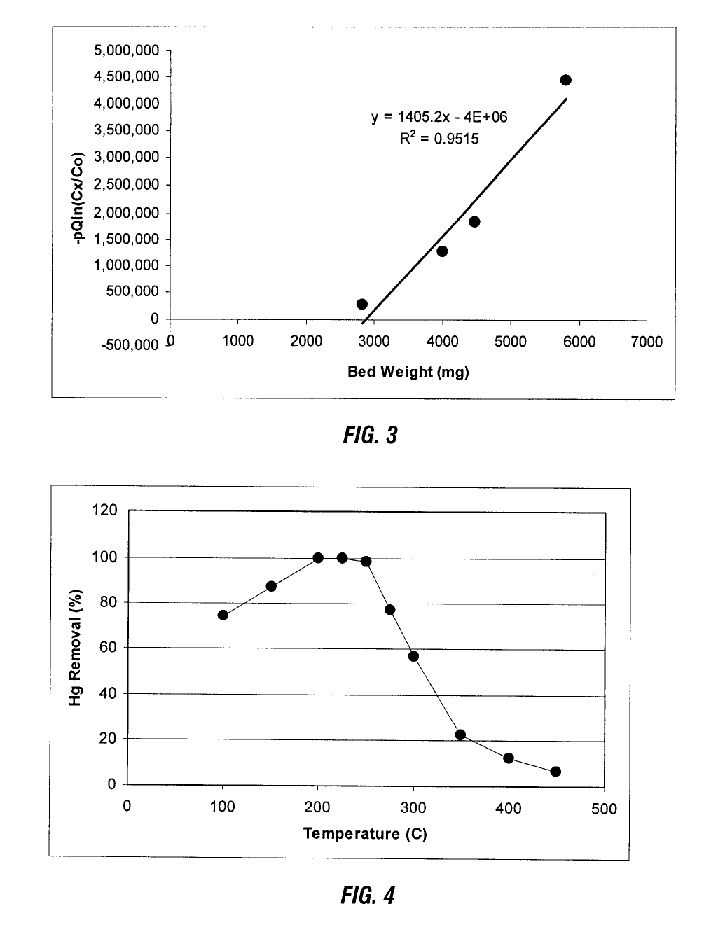

FIG. 3 illustrates the results obtained from the Wheeler equation for tests performed with a flow rate of 500 mL/min and a furnace temperature of 275° C., as set forth in Example 1.

FIG. 4 illustrates Hg collection efficiency as a function of Fe bed temperature, as set forth in Example 1.

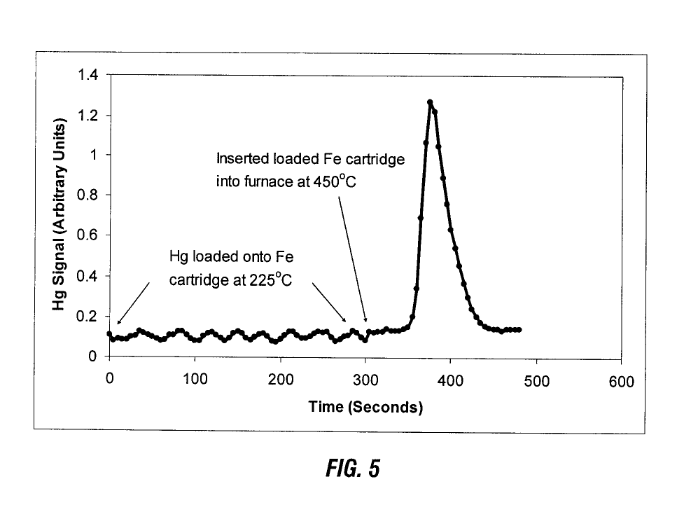

FIG. 5 illustrates Hg signal during loading and regeneration of Fe cartridge, as set forth in Example 1.

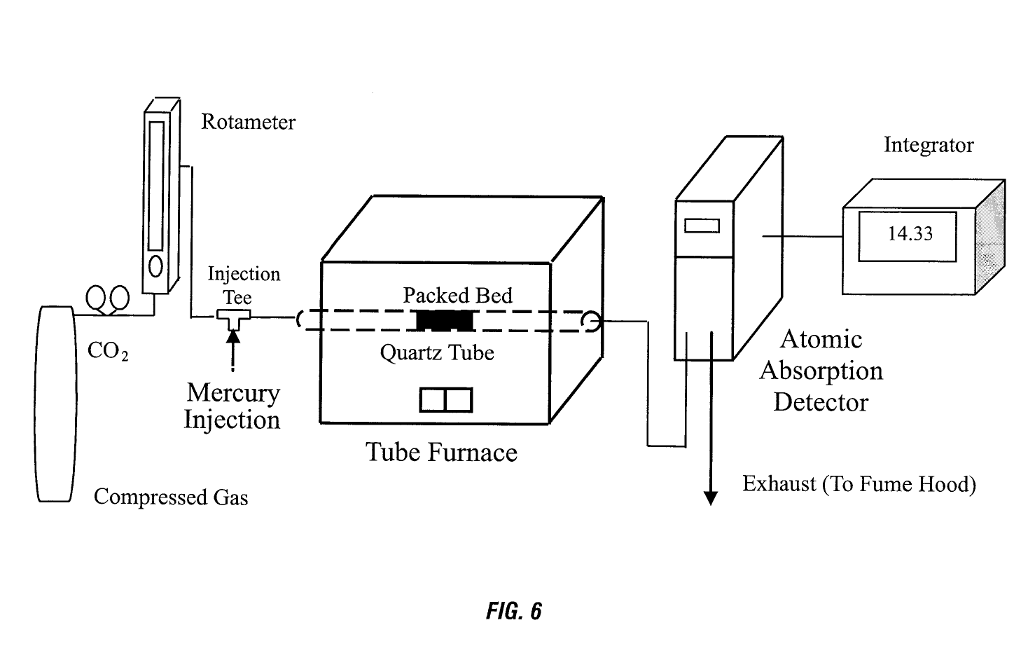

FIG. 6 illustrates the experimental set-up for measuring mercury removal efficiency of Fe in accordance with Example 2.

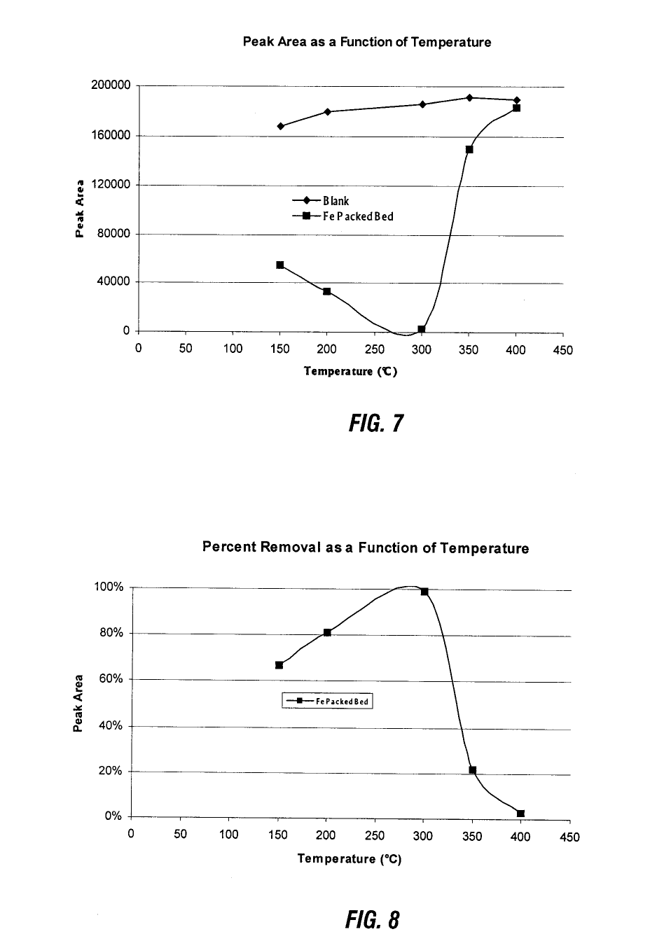

FIG. 7 illustrates the peak area as a function of temperature of an Fe packed bed versus that of an unpacked bed, in accordance with Example 2.

FIG. 8 illustrates the percent removal of Hg as a function of temperature of an Fe packed bed versus that of an unpacked bed, in accordance with Example 2.

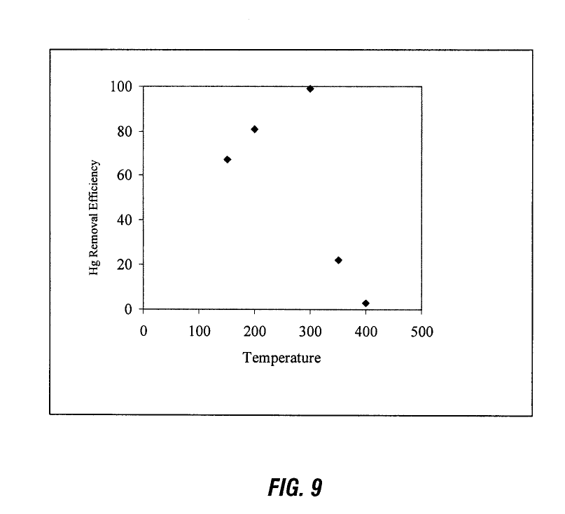

FIG. 9 illustrates Hg chemisorption efficiency onto microscopic particles of elemental Fe in accordance with Example 2.

### DETAILED DESCRIPTION OF THE INVENTION

The present invention relates to an improved means of detecting and preventing the emission of mercury from industrial waste streams. Using precombustion control, nearly all of the mercury is chemisorbed onto elemental iron at elevated temperatures. In addition, the iron sorbent material appears to be regenerable by heating the sorbent to a second elevated temperature in an inert environment. Furthermore, the surrounding gas matrix of the present invention is relatively stable since it does not contain SO₂ or NO₂.

The method of the invention involves heating a mercury-containing material to generate a gas stream. The mercury-containing material can be of from any source, including, but not limited to, gas streams from coal-fired power plants, chlor-alkali plants, and automobile scrap. The material is then contacted with an iron (Fe) containing sorbent. The material is heated to a temperature that is sufficient to chemisorb the mercury onto the sorbent, which will generally range from about 100-350° C. The preferred temperature range for mercury sorption is from about 225-300°, with about 300° C. being most preferred.

There is no upper or lower limit on the rate of flow of the Hg-containing gas stream that can be contacted with the Fe sorbent. In this regard, it is desired, although not required, that the gas stream flow at a rate such that the Fe sorbent is able to fully chemisorb the Hg contained therein. In general, the present inventors have determined that a rate of between about 100-500 mL/min for the gas stream allows for maximum Hg sorption, with about 500 mL/min being preferred.

The Fe sorbent can be of various types including, but not limited to Fe filings, granules, and powders. Such Fe sorbents can be obtained from numerous commercial sources including Fisher Scientific Company and Aldrich. The purity and particle size of the Fe source will impact its collection efficiency of Hg. In this regard, the smaller the particle size of the iron, the more absorption area that is available for the Hg. For this reason, it is preferred to use microscale iron having a particle size of 100 mesh or less as this provides for enhanced Hg vapor from the gas stream. Preferred iron particles have a particle size of between about 20-100 mesh, while most preferred iron particles have a size of between about 30-50 mesh, with about 40-50 mesh (420-300 microns) being a preferred particle size range that is practical to achieve. However, the finer the Fe sorbent, the more surface area available for Hg sorption, and the more enhanced the Hg sorption. The chemisorption of Hg onto iron preferably occurs in a non-oxidizing, inert environment to prevent potential reactions that can occur in environments containing such gases as SO₂ and NOₓ.

Following Hg chemisorption, the Fe sorption agent can be regenerated by heating the sorbent to a second temperature sufficient to release the Hg from the sorbent. This second temperature will generally range from about 350-500° C., with about 400° C. being preferred. This step also preferably occurs in a non-oxidizing, inert environment.

The following examples are offered to illustrate but not limit the invention. Thus, they are presented with the understanding that various formulation modifications as well as method of delivery modifications may be made and still be within the spirit of the invention. EXAMPLE 1

### Use of Elemental Iron for Removing Mercury Vapor from Inert Gas Streams

The goal of this study was to provide an assessment of the feasibility of use of elemental iron as a Hg vapor sorbent in hot gas streams. Tests were performed to determine adsorption capacity and adsorption rate for baseline conditions; the effect of temperature on adsorption; and performance for different kinds of iron samples.

A 40-50 mesh (420-300 microns) sample of Fe was used for most of the testing. The sorption of Hg onto the Fe was extremely sensitive to temperature. At the gas flow rate (500 mL/min) where chemical kinetics rather than mass transfer effects predominate, the best temperature for Hg sorption using that Fe sample was about 225° C. Sorption capacity at that temperature and gas flow rate was about 135 ng Hg per gram of Fe sorbent. The Ottumwa Generating station is estimated to emit 45 kg of Hg per year, or an average of roughly 5.2 grams Hg per hour. Complete removal of this amount of Hg would require about 38,000 kg (38 tons) of Fe per hour. However, a commercial system would employ a much finer sorbent, on the order of 5 micron size, which provide a surface area enhancement of 5000, or about 0.675 mg Hg per gram of Fe sorbent. This would greatly decrease the amount of Fe needed. Furthermore, the results achieved show that the Fe can easily be regenerated by heating to temperatures of 400° C. or more, which would limit the Fe requirement for a plant to a few tens of tons.

Similar Hg sorption tests with two other Fe samples indicated that those samples had little or no Hg sorption capacity under the conditions tested. The reasons for this are not currently known, but may reflect differences in contaminants or surface oxidation of the samples.

Materials and Methods

Unless otherwise noted, all work was performed with elemental Hg vapor in dry CO₂ flowing over packed beds. A CO₂ atmosphere was used for all tests since CO₂ is the likely gas to be used during the mild heating of coal. The packed beds were heated to the desired temperature in a Lindberg/Blue M tube furnace. Various aspects of the work are discussed separately below.

Fe Samples

Two different Fe samples were selected for the majority of the testing. The first one was minus 40 mesh Fe filings from Fisher Scientific Company. That sample was sieved to obtain a 40-50 mesh (420-300 microns) size fraction, which was used for all testing unless otherwise noted. The vendor has no information on the purity of this Fe. The purity of this sample is not yet known. This Fe was selected for use because preliminary tests indicated that it collected Hg in the temperature region of interest.

The second Fe sample was 10-40 mesh Fe granules from Aldrich, and has a purity of 99.999% based on trace metal analysis. The 10-40 mesh Fe was sieved to obtain a 30-40 mesh (590-420 microns) size fraction. The 30-40 mesh size fraction of this Fe sample was used for all testing. This Fe was selected because of its very high purity, and because of the fact that chemical purity can be an important parameter in surface sorption properties. This in turn can have a major impact on process economics if Hg collection efficiencies are significantly affected by the chemical purity. In addition, the chemical purity greatly affects purchasing costs as well, which clearly has a considerable impact on the overall economics.

In addition to those two Fe samples, a third sample was selected for some very limited testing. That sample was electrolytically reduced Fe powder from Acros Organics. It has a purity of 96%, and was of interest because of the relatively low purity (compared to the Fe granules from Aldrich), and also because of its finer mesh size. However, the sample was found to be nearly 100% minus 325 mesh (<44 microns). The small particle sizes for that sample makes working with packed beds difficult. Therefore, very minimal testing was performed with that sample.

Methods for Introducing Hg into the Gas Stream

Generation of Continuous Hg Streams. A VICI Metronics Dynacalibrator with an elemental Hg permeation tube was used to generate the continuous Hg streams for these tests. The calibrated permeation tube was heated at 30.0° C., which provided a Hg release rate of 30±2 ng/min. A gas stream passes continuously over the permeation tube to provide the span gas. Since the Hg emission rate from the permeation tube is constant at a given temperature, changing the gas flow rate over the permeation tube will also change the Hg concentration in the span gas. However, even though the Hg concentration changes with changing flow rate, the mass flow rate of Hg (ng/s) into the Fe bed is constant, regardless of the gas flow rate. The calibrator is normally operated with air as both the “zero gas” (used to zero the analyzer) and the span gas (containing Hg) matrix. The calibrator was initially re-plumbed and set up so that the span gas used a CO₂ matrix, while air was initially used for the zero gas (see discussion in “Preliminary Tests” below).

Injections of Hg Vapor. In many tests, known amounts of elemental Hg vapor were injected into a carrier gas passing over the sorbent beds. In contrast to using continuous Hg streams from a permeation tube (discussed above), the Hg injections were performed using a gas-tight syringe. For this work, Hg-saturated air above a pool of liquid elemental Hg was used. A gas volume of 1 mL of Hg-saturated air has approximately 10 ng of elemental Hg vapor.

Analysis of Gas Streams for Elemental Hg

Gases exiting the sorbent bed were continuously analyzed for Hg using a UV-based Hg detector. The detector was connected to a strip chart recorder, an integrator (for determining peak areas), and an automated computerized data acquisition system (for importing data files into Excel).

Study on Chemical Kinetics vs. Mass Transfer

Theory. In order for the test results to be meaningful for engineering design applications, it is important that the tests are performed at sufficiently high velocity to ensure that chemical kinetics rather than mass transfer is the primary factor influencing the test results. Therefore, a series of tests were performed at different gas flow rates to ensure that the gas flow rates being used were high enough to avoid mass transfer effects. This was done by using a simplified form of the Wheeler equation:

$${t}_{b} = \frac{{W}_{s}}{{QC}_{o}} {W}_{B} - \frac{{P}_{B} {W}_{s}}{{C}_{o} {k}_{o}} ln ( {C}_{o} / {C}_{x} )$$

At each flow rate tested, several different Fe bed weights were used. For each flow rate, the different Fe bed weights (in mg) were plotted against the term “−ρ_{b}Qln(C_{X}/Cₒ)”, where “ρ_{b}” is the bulk bed density in mg/cm³, “Q” is the volumetric gas flow rate in cm³/min, “C_{X}” is the Hg concentration exiting the Fe bed at a given time (t_{b}) from time “zero,” and “Cₒ” is the inlet Hg concentration. After plotting those data for each gas flow rate, chemical kinetics predominate if the slopes of the lines are the same. Furthermore, the sorption capacity (Wₛ) can be calculated by using:

$${W}_{S} = \frac{slope}{\vert y - intercept \vert} ( {C}_{o} Q t )$$

In that equation, the slope of the curve discussed above is divided by the “y” intercept and then multiplied by the inlet Hg concentration (“Cₒ”, in units of mg/L), the gas flow rate (in L/min), and the time “t” (in minutes) used to calculate “C_{X}/Cₒ” for the plot of bed weight versus “−ρ_{b}Qln(Cₓ/Cₒ)”.

Preliminary Tests. Results from initial breakthrough tests performed at a nominal temperature of 275° C. indicated that 50-70% of the Hg stream was breaking through the bed immediately, even when using large fixed beds of Fe under flow and temperature conditions where effective Hg capture was anticipated. After the initial rapid breakthrough, the Hg concentration in the outlet stream continued to increase, but it increased very slowly since Hg sorption mechanisms were now occurring. Thus, after the initial rapid and large breakthrough of the Hg (essentially no Hg removal), sorption of the Hg began and the breakthrough curve subsequently followed a more typical trend. The possibility of channeling was considered. However, this was viewed as being unlikely in view of the fact that a 5-inch bed of 40-50 mesh Fe was being used, the gas flow rate was only 200 mL/min, and the results were reproducible when using fresh beds of Fe.

After performing tests to determine what was causing the unusual results, it appears that the problem of immediate breakthrough is related to the fact that air passing over the fixed bed was used to zero the Hg detector, while the Hg span gases consisted of a CO₂ matrix. The issue is somehow related to the use of air versus CO₂. If the instrument was zeroed with air, followed by passing span gases (CO₂ and Hg) over the Fe bed, a very large and immediate breakthrough is observed. However, if the instrument is zeroed with CO₂, followed by passing span gases (CO₂ matrix) over the bed, excellent breakthrough curves are repeatedly obtained. In the former case, it is unclear what is causing the rapid breakthrough. One possibility is that the much lower thermal conductivity of CO₂ relative to air is causing a temporary temperature dip to occur after switching from air (zero gas) to CO₂ (span gas). In that case, a large breakthrough is observed until the temperature of the gas stream (and the fixed bed) is brought back up to the desired temperature. Another possibility is that air (oxygen) is actually somehow inhibiting the Hg collection mechanism. In that case, a large breakthrough is observed until the air is purged out of the reaction tube, at which point sorption of the Hg can begin. This issue was not explored further, although it may ultimately provide insight into successful use of iron as a Hg sorbent. Instead, the calibrator was re-plumbed and set up so that CO₂ was used for both the zero gas and the span gas. With this modification, no more problems with immediate breakthrough were encountered.

Follow-up Tests on Chemical Kinetics. After switching to CO₂ for both the “zero” gas and the “span” gas containing Hg, tests were performed to determine whether or not Hg sorption results are primarily affected by chemical kinetics or mass transfer effects. For those tests, the Wheeler equation discussed above was used to plot data from breakthrough tests. Packed beds of the 40-50 mesh Fe (from Fisher Scientific Company) were used in a ¼″ OD quartz tube. The beds were heated to a nominal temperature of 275° C. Depending on the gas flow rate being used, the bed weights varied from about 1000 to 6000 mg. Gas flow rates of 100, 300, and 500 mL/min (“Q” values of 100, 300, and 500 cm³/min) were tested. The packed bed density (ρ_{b}) was determined to be 2960 mg/cm³ for this particular Fe sample. A summary of some of the other testing variables is set forth below in Table 1:

TABLE 1
Variables in the Testing to Study Chemical
Kinetics with the Wheeler Equation.

| Gas Flow Rate | Inlet Hg | Time Used to |
|---|---|---|
| (cm³/min) | Concentration (ng/L) | Determine “Cx” (min) |
| 100 | 300 | 5.0 |
| 300 | 100 | 3.0 |
| 500 | 60 | 10.0 |

If results from those tests (using the Wheeler equation) indicated that chemical kinetics predominate, then any of those flow rates would be acceptable for subsequent experiments in this study. Similarly, if chemical kinetics were found to be the primary factor affection the results from the breakthrough tests while using the relatively coarse (40-50) mesh Fe particles, then chemical kinetics can also be assumed to be the predominant factor when using finer particle sizes as well.

Results from the tests performed at 100, 300, and 500 mL/min are shown in FIGS. 1, 2, and 3, respectively. As shown by those plots, mass transfer effects have a large impact on the results when flow rates of 100 and 300 mL/min are used, as indicated by the fact that the slopes of the two lines are a factor of about 4.5 times different from one another. The slope of the line obtained at 500 mL/min is only about 40% higher than that obtained at 300 mL/min. This indicates that test conditions are getting close to being dominated by chemical kinetics rather than mass transfer effects when using a flow rate of 500 mL/min.

For the tests performed at 100, 300, and 500 mL/min, the sorption capacity (Ws) was calculated to be about 200, 50, and 100 ng Hg/gram sorbent, respectively. Thus, a value of about 100 ng Hg/gram sorbent can be used as a reasonable estimate for the sorption capacity for this Fe material.

Hg Collection Efficiency vs. Temperature

Preliminary tests previously indicated that the optimum temperature for Hg collection was roughly 300° C. Subsequent tests were performed in greater detail and with more precise control of experimental variables than those performed previously. This allowed the critical Hg absorption region to be more accurately determined.

For these tests, 0.5-ng injections of elemental Hg vapor were made into a CO₂ carrier gas stream passing over Fe beds at a rate of 500 mL/in (at STP). All Fe beds had a mass of 2.00 grams, and a fresh Fe bed was used for each temperature tested. The 40-50 mesh Fe from Fisher Scientific Company was used for all tests. Prior to the Hg injections, the Fe bed was allowed to equilibrate for 10 minutes at each furnace temperature. All injections were performed in duplicate or triplicate, and the average peak area associated with the injections performed at a given furnace temperature were plotted. Peak areas for individual injections were within 5% of the mean values. Peak areas obtained for Hg injections into an empty quartz tube served as the reference point representing 0% Hg removal. Peak areas observed for the tests with Fe beds were referenced to those obtained in the absence of Fe in order to calculate the Hg removal efficiency. Results of those tests are shown in FIG. 4.

The data show that, from an Hg collection standpoint, it may be best not to exceed 250° C. (480° F.). However, the thermal evolution of Hg from the coal can still be performed at higher temperatures (i.e., 600° F.), followed by collection of the Hg released from the coal in a cool-down zone containing the Fe sorbent.

Thermal Regeneration of Iron

A quick set of tests was performed to demonstrate the release of sorbed Hg when heating the Fe bed (containing Hg) at 450° C. The 40-50 mesh Fe from Fisher Scientific Company was used for this demonstration. During the Hg loading step, elemental Hg vapors were injected into a CO₂ carrier gas stream flowing over a 2-gram Fe bed at a rate of 500 mL/min (at STP). The Fe bed was heated at a nominal temperature of 225° C. while Hg was being injected. Through a series of injections, a total of about 40 ng of Hg was loaded onto the 2-gram Fe bed. After loading the Hg onto the Fe, the sorbent bed was removed from the tube furnace and the temperature of the tube furnace was increased to 450° C. The Fe bed was then inserted into the preheated 450° C. furnace while under a continuous CO₂ purge at 500 mL/min. Gases exiting the Fe bed were continuously monitored for Hg during both the Hg loading and thermal regeneration steps. Results of this test are shown in FIG. 5. The signal observed during sample loading was scalloped because of temperature cycling in the tube furnace and because of the high sensitivity of Hg sorption behavior to temperature. The desorption signal looked excellent, and the area associated with the signal from the desorbed Hg was within 10% of the value expected based on the amount of Hg injected.

Sorption Capacity of Different Fe Samples

In the studies of chemical kinetics using the Wheeler equation, Hg sorption capacities ranged from 50-200 ng Hg per gram of sorbent, depending on the experimental conditions. Those tests were performed using a bed temperature of 275° C. and gas flow rates of 100, 300, and 500 mL/min.

Follow-up tests were performed to assess Hg sorption capacity using three different Fe samples, including the 40-50 mesh Fe used earlier. The three Fe samples used are discussed above in the section entitled “Fe Samples”. For these follow-up tests, a gas flow rate of 500 L/min was used in all cases. Also, after reviewing the data obtained for Hg collection efficiency versus collection temperature, the collection temperature was changed from 275° C. to 225° C. Previous tests using the Wheeler equation indicated that Hg concentration did not significantly affect Hg sorption capacity. Those tests were performed using different gas flow rates and different inlet Hg concentrations. Based on the results from those tests, the tests performed to determine Hg sorption capacities of the three different Fe samples were performed using a single inlet Hg concentration. Specifically, continuous streams of CO₂ containing 60 ng Hg/L were used to obtain breakthrough curves for analysis using the Wheeler equation. In order to decrease the range of “Cₓ” values observed for a given analysis time, bed weights were changed in smaller increments than what was previously used.

For the 40-50 mesh Fe (used for all earlier tests), bed weights were changed in increments of 0.5 grams, as opposed to the 1-gram increments used previously. The sorption capacity was calculated to be about 135 ng Hg/gram of sorbent. This is slightly higher than obtained earlier using the same gas flow rate, and is due to the slightly better collection efficiency observed at 225° C. as opposed to 275° C. Although the sorption capacity of this Fe sample is somewhat low, it must be emphasized that relatively large particles were used. In actual field applications, much finer Fe particles would be used. This will greatly increase the amount of Hg collected per gram of Fe (due to the much higher surface area per gram of sorbent). In addition, an evaluation of the Fe sorbent technology cannot be based on sorption capacities alone. The Fe is very inexpensive, and relative costs between different sorbent materials must be factored in. Furthermore, the regenerability of the Fe greatly increases the utility of that sorbent material.

Similar tests were attempted using the 30-40 mesh high purity Fe. However, no Hg sorption could be detected. There was total and immediate (within 5 seconds) breakthrough of the Hg, even when using large bed weights of 8 grams (giving a bed length of about 7 inches). For comparison, the tests with the 40-50 mesh Fe involved bed weights of 3 to 4.5 grams, and bed lengths of roughly 3-5 inches. Even if the relatively coarse Fe (i.e., the 30-40 mesh sample) had only 10% of the surface area as the 40-50 mesh material, breakthrough should not have been observed for about 2 minutes when using the 8-gram bed. The reason for the immediate breakthrough is not known.

For the powdered Fe, problems were encountered because of severe backpressure problems. With such a fine powder, the Fe bed acted like a nearly total plug in the system. The desired flow rate could not be achieved (even after increasing the delivery pressure substantially) when using bed weights of 0.2 grams or more. However, the desired gas flow rate of 500 mL/min could be achieved when using a bed weight of only 0.1 grams. With that bed weight, complete Hg breakthrough was observed immediately. It is not known if these results were a result of insufficient surface area, or whether some other factor was the cause.

No other suitable Fe samples were located. All the other Fe samples that were identified were either too fine or were even more coarse than the 30-40 mesh sample that was tested. In the former case, backpressure problems would be too severe. In the later case, there are concerns about the lack of sufficient surface area for effective Hg capture. Therefore, no additional Fe sources were tested.

The Hg sorption capacity is largely a function of surface area, among a number of other variables. In order to aid in the interpretation of results obtained for Hg sorption capacities for each of the Fe sources tested, each of the types of Fe used in this study is currently being analyzed for total surface area using the conventional BET isotherm technique. Hg sorption capacity can then be calculated in terms of ng Hg per unit surface area of sorbent.

### EXAMPLE 2

### Hg Removal with Fe

Mercury removal efficiencies of Fe were measured at various temperatures using the experimental set-up shown in FIG. 6. Liquid mercury in a sealed flask was used as a source for mercury vapor. A 1.0 mL Hamilton Gastight syringe was used to withdraw 0.5 mL of mercury-laden air through a 6 mm Teflon faced septum on the top of the flask. The mercury was injected into a carbon dioxide carrier gas stream through a second septum. The carrier gas source was a compressed gas cylinder that supplies carbon dioxide at a constant pressure of 10 psi. The carbon dioxide flow rate was controlled with a rotameter upstream of the mercury injection point to maintain a constant flow of 50 mL/min. Downstream of the mercury injection point, the ¼″ PTFE lines were connected to a 6 mm OD×4 mm ID quartz tube using PTFE compression fittings. The quartz tube is 20 inches in length, and a notch was placed 8″ into the tube to hold a packed bed. The packed bed was formed by placing a small piece of quartz wool against the notch, followed by inserting supported Fe particles (40 mesh, Fisher Scientific), and by another small piece of quartz wool to hold the packed bed in place. The quartz tube was centered in a Lindberg/Blue Model TF55030A tube furnace equipped with an Athena XT16 temperature controller.

During an Hg removal test the temperature of the Fe particle samples were varied between 150° C. and 300° C. Downstream of the tube furnace, the gas mixture was analyzed for mercury with a Thermo-Separations Products MercuryMonitor® 3200 Atomic Adsorption detector. The analog signal from the detector was connected to a Hewlett-Packard 3395 Integrator and the peak areas from the detector signal were determined. The efficiency was determined by comparing peak area obtained with a packed bed compared to the peak area obtained when no packed bed was placed in the tube. At a given temperature, the efficiency of the packed bed was determined by comparing the peak area obtained with a backed bed compared to the peak area obtained when no packed bed was placed in the tube, as set forth in Table 2 below. These results are graphically depicted in FIGS. 7 and 8. Each temperature was repeated twice, and the results were averaged. When a temperature of 275° C. was used in the tube furnace, no mercury was detected by atomic adsorption. When the temperature was increased to 500° C., a peak was generated that had the same area as the peak obtained from a blank when no iron filings were in the quartz

TABLE 2

| | | Temp | Peak Areas | | | |
|---|---|---|---|---|---|---|
| | | ° C. | 1 | 2 | Average | % Reduction |
| No Fe | 1 | 150 | 169470 | 165933 | 167702 | |
| | 2 | 200 | 179244 | 179752 | 179498 | |
| | 3 | 300 | 184131 | 186661 | 185396 | |
| | 4 | 350 | 188442 | 193366 | 190904 | |
| | 5 | 400 | 185949 | 192881 | 189415 | |
| Iron | 1 | 150 | 59619 | 50643 | 55131 | 67% |
| (40 Mesh) | 2 | 200 | 30800 | 35751 | 33276 | 81% |
| | 3 | 300 | 4063 | 859 | 2461 | 99% |
| | 4 | 350 | 139820 | 159062 | 149441 | 22% |
| | 5 | 400 | 183362 | 183209 | 183286 | 3% |

The results are shown in FIG. 9, which reveals almost 100% chemisorption of Hg onto microscopic particles of elemental Fe at temperatures of approximately 300° C. This occurs near the optimum temperature for thermal evolution of Hg from the coal prior to combustion. Furthermore, the sorbent material proved to be regenerable by heating to about 400° C. in an inert environment (which will be used during the thermal evolution of Hg from the coal).

Persons skilled in the art will readily understand that the processes described above may be preformed in a one-step process, or in several steps. In the alternative, the process of the invention may take place in several steps and in numerous chambers or containers in a factory or manufacturing process. Persons skilled in the art will also readily appreciate that the processes of this invention may be accomplished using a variety of equipment and techniques that are well known in the art, including conveyor belts, chambers, condensers, centrifuges, distillers, etc. The specific equipment used is not critical to the process.

It should be appreciated that minor modifications of the composition and the ranges expressed herein may be made and still come within the scope and spirit of the present invention.

Having described the invention with reference to particular compositions, theories of effectiveness, and the like, it will be apparent to those of skill in the art that it is not intended that the invention be limited by such illustrative embodiments or mechanisms, and that modifications can be made without departing from the scope or spirit of the invention, as defined by the appended claims. It is intended that all such obvious modifications and variations be included within the scope of the present invention as defined in the appended claims. The claims are meant to cover the claimed components and steps in any sequence which is effective to meet the objectives there intended, unless the context specifically indicates to the contrary.

What is claimed is:

1. A method of removing mercury from gas streams comprising:
heating a mercury-containing material to generate a mercury-containing gas stream;
contacting the gas stream with an iron-containing sorbent; and said heating step taking place at a first temperature that is sufficient to chemisorb the
mercury onto the sorbent.

2. The method of claim 1 whereby the first temperature ranges from about 100-350° C.

3. The method of claim 2 whereby the first temperature is about 300° C.

4. The method of claim 1 whereby the iron-containing sorbent comprises iron particles.

5. The method of claim 4 whereby the iron-containing particles are microscopic.

6. The method of claim 5 whereby the iron-containing particles are of a size of 100 mesh or less.

7. The method of claim 6 whereby the iron-containing particles are of a size ranging from about 20-100 mesh.

8. The method of claim 7 whereby the iron-containing particles are of a size ranging from about 30-50 mesh.

9. The method of claim 8 whereby the iron-containing particles are a size of about 40 mesh.

10. The method of claim 1 further including the step of heating the iron-containing sorbent with chemisorbed mercury to a second temperature sufficient to regenerate the sorbent.

11. The method of claim 10 whereby the iron-containing sorbent with chemisorbed mercury is heated to a range of between about 350-500° C.

12. The method of claim 11 whereby the iron-containing sorbent with chemisorbed mercury is heated to a temperature of about 400° C.

13. The method of claim 1 whereby the contacting step occurs in a non-oxidizing environment.

14. The method of claim 1 whereby the mercury-containing material is coal.

15. The method of claim 1 whereby the heating and contacting steps occur prior to burning the mercury-containing material.

16. The method of claim 1 whereby the heating step occurs in an inert environment.

17. The method of claim 1 whereby gas flow rate of the gas in the gas stream is between about 100-500 mL/min.
